(19) United States
(12) Patent Application Publication
(10) Pub. No.: US 2009/0150812 A1
(43) Pub. Date: Jun. 11, 2009

(54) Method and system for data source and modification tracking

(75) Inventors: Christopher Richard Baker, Fishers, IN (US); Jason Bush, Indianapolis, IN (US); Morris J. Young, Indianapolis, IN (US); Schuyler Buck, Muncie, IN (US); Igor Gejdos, Indianapolis, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,888

(22) Filed: Dec. 7, 2007

(51) Int. Cl. G06F 3/048; G06F 3/14

(52) U.S. Cl. 715/764

(57) ABSTRACT

A system and method for displaying data are disclosed, the method being applicable to a system comprising a computing device having an output device and software programs, and, optionally, an input device. The programs are configured to provide a screen display having display objects. The display objects distinguish the data according to the sources of the data.

### FIELD OF THE INVENTION

The invention relates to a method and system for displaying information on an output device. More particularly, the invention relates a method and system for providing screen displays that distinguish data according to the source of the data.

### BACKGROUND OF THE INVENTION

Many fields of medical treatment and healthcare require monitoring of certain physiological parameters. Technological advancements in medicine led to the increased use of medical devices, e.g., meters and infusion pumps, to collect medical data, and of healthcare data management systems. Healthcare data management methods and systems traditionally developed for use in healthcare facilities and health management organizations are increasingly used by patients, care givers, and others. U.S. Pat. No. 7,103,578 and U.S. Published Application No. 2004/0172284 disclose two such methods and systems. Some healthcare data management systems are able to transfer data between them.

A common feature of healthcare data management systems is the ability to convey information. Information can include raw data, graphical representations of data such as statistical display objects, explanations and textual interpretations, inferential information and so on. Communication and understanding can be improved by using interactive graphs to convey information. In one particular embodiment, the development of graphical user interfaces (GUI) facilitates user interaction with data processing and other software applications. In a typical embodiment, a GUI can display a number of display objects that are individually manipulable by a user utilizing a user input device. For example, the user can utilize a computer keyboard, mouse, touch screen, touch pad, roller ball or voice commands and the like to select a particular display object and to further initiate an action corresponding to the selected display object.

The general systems that display data and facilitate the modification and addition of data may inadvertently convey a level of confidence in the accuracy and reliability of the data that is unfounded. Generally, a user of a system that automatically receives data from a meter will naturally trust the accuracy and reliability of the data. However, data that is manually added and modified might not deserve the same level of trust deserved by data obtained from medical devices and other reliable sources.

### SUMMARY OF THE INVENTION

A system and method for displaying data is provided. The system comprises a computing device and computer programs. The method may be implemented in the computing device. The computing device contains data, has an output device, and may comprise one or more input devices for registering user inputs. The programs generate screen displays incorporating display objects and can process a variety of user inputs. Display objects can be activated by registration of user inputs corresponding to display objects to cause performance of some action within the computing device.

In accordance with an aspect of the present invention, a method for displaying information in a screen display presented on the output device is provided. In accordance with the method, a computer program tracks the source of data and provides display objects to a screen display corresponding to the data source. The source of data may comprise the device where the data originates, the specific model or type of device, a type of data modification, and the identification of the user who modified the data. The display objects are configured to distinguish data according to the source of the data.

In accordance with a further aspect of the present invention, a method for displaying information in a screen display presented on the output device is provided. In accordance with the method, selection criteria is provided to select data according to a trust level associated with the data. The screen display is configured to distinguish data by displaying display images corresponding to selected data.

In accordance with a further aspect of the present invention, a system for displaying information in a screen display is provided. The system comprises a computer device and computer programs. Further, the system also comprises a medical device configured to track the source of data. In another embodiment, the computing device is integrated with the medical device. In a further embodiment, the computing device is coupled with the medical device.

### DESCRIPTION OF THE DRAWINGS

The foregoing aspects of this invention will become more readily appreciated as the same become better understood by reference to the following detailed description when taken in conjunction with the accompanying drawings.

FIG. 1 is a conceptual diagram of a system according to the invention comprising a computing device having a modulated signal transceiver configured to access a medical device.

FIG. 2 is a screen display according to the invention depicting a logbook tabs portion, display objects, and trust icons characterized by the shape of pencils;

FIG. 3 is a screen display according to the invention showing display objects including point markers.

FIG. 4 is a screen display according to the invention depicting a record editing window.

FIG. 5 is the logbook tabs portion of the screen display of FIG. 2 depicting a diary tab and showing display objects and trust icons.

FIG. 6 is the logbook tabs portion of the screen display of FIG. 2 depicting a record list tab and displaying trust icons, and the original source of data.

FIG. 7 is an alternate view of a logbook tabs portion of a screen display depicting a record list tab and displaying a trust icon characterized by the shape of two pencils.

FIG. 8 is a screen display according to the invention showing point markers and trust icons characterized by the shape of one pencil and two pencils.

FIG. 9 is a screen display according to the invention showing point markers and trust icons characterized by the shape of numbers.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

Concepts described below may be further explained in one of more of the co-filed patent applications entitled HELP UTILITY FUNCTIONALITY AND ARCHITECTURE (Atty. Docket: ROCHE-P0033), METHOD AND SYSTEM FOR GRAPHICALLY INDICATING MULTIPLE DATA VALUES (Atty. Docket: ROCHE-P0039), SYSTEM AND METHOD FOR DATABASE INTEGRITY CHECKING (Atty. Docket: ROCHE-P0056), PATIENT-CENTRIC HEALTHCARE INFORMATION MAINTENANCE (Atty. Docket: ROCHE-P0043), EXPORT FILE FORMAT WITH MANIFEST FOR ENHANCED DATA TRANSFER (Atty. Docket: ROCHE-P0044), GRAPHIC ZOOM FUNCTIONALITY FOR A CUSTOM REPORT (Atty. Docket: ROCHE-P0048), METHOD AND SYSTEM FOR SELECTIVE MERGING OF PATIENT DATA (Atty. Docket: ROCHE-P0065), METHOD AND SYSTEM FOR PERSONAL MEDICAL DATA DATABASE MERGING (Atty. Docket: ROCHE-P0066), METHOD AND SYSTEM FOR WIRELESS DEVICE COMMUNICATION (Atty. Docket: ROCHE-P0034), METHOD AND SYSTEM FOR SETTING TIME BLOCKS (Atty. Docket: ROCHE-P0054), METHOD AND SYSTEM FOR ENHANCED DATA TRANSFER (Atty. Docket: ROCHE-P0042), COMMON EXTENSIBLE DATA EXCHANGE FORMAT (Atty. Docket: ROCHE-P0036), METHOD OF CLONING SERVER INSTALLATION TO A NETWORK CLIENT (Atty. Docket: ROCHE-P0035), METHOD AND SYSTEM FOR QUERYING A DATABASE (Atty. Docket: ROCHE-P0049), METHOD AND SYSTEM FOR EVENT BASED DATA COMPARISON (Atty. Docket: ROCHE-P0050), DYNAMIC COMMUNICATION STACK (Atty. Docket: ROCHE-P0051), SYSTEM AND METHOD FOR REPORTING MEDICAL INFORMATION (Atty. Docket: ROCHE-P0045), METHOD AND SYSTEM FOR MERGING EXTENSIBLE DATA INTO A DATABASE USING GLOBALLY UNIQUE IDENTIFIERS (Atty. Docket: ROCHE-P0052), METHOD AND SYSTEM FOR ACTIVATING FEATURES AND FUNCTIONS OF A CONSOLIDATED SOFTWARE APPLICATION (Atty. Docket: ROCHE-P0057), METHOD AND SYSTEM FOR CONFIGURING A CONSOLIDATED SOFTWARE APPLICATION (Atty. Docket: ROCHE-P0058), METHOD AND SYSTEM FOR DATA SELECTION AND DISPLAY (Atty. Docket: ROCHE-P0011), METHOD AND SYSTEM FOR ASSOCIATING DATABASE CONTENT FOR SECURITY ENHANCEMENT (Atty. Docket: ROCHE-P0041), METHOD AND SYSTEM FOR CREATING REPORTS (Atty. Docket: ROCHE-P0046), METHOD AND SYSTEM FOR CREATING USER-DEFINED OUTPUTS (Atty. Docket: ROCHE-P0047), DATA DRIVEN COMMUNICATION PROTOCOL GRAMMAR (Atty. Docket: ROCHE-P0055), HEALTHCARE MANAGEMENT SYSTEM HAVING IMPROVED PRINTING OF DISPLAY SCREEN INFORMATION (Atty. Docket: ROCHE-P0031), and METHOD AND SYSTEM FOR MULTI-DEVICE COMMUNICATION (Atty. Docket: ROCHE-P0064), the entire disclosures of which are hereby expressly incorporated herein by reference. It should be understood that the concepts described below may relate to diabetes management software systems for tracking and analyzing health data, such as, for example, the ACCU-CHEK® 360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the ACCU-CHEK® Active, ACCU-CHEK® Aviva, ACCU-CHEK® Compact, ACCU-CHEK® Compact Plus, ACCU-CHEK® Integra, ACCU-CHEK® Go, ACCU-CHEK® Performa, ACCU-CHEK® Spirit, ACCU-CHEK® D-Tron Plus, and ACCU-CHEK® Voicemate Plus, all provided by Roche Diagnostics or divisions thereof.

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

The present invention relates to a method and system for data source and modification tracking. The system comprises a computer, applications, and databases. An application, computer program, or program, is here, and generally, conceived to be a sequence of computer instructions representing steps of methods for achieving desired results. The instructions are processed by a computer and require physical manipulations of physical quantities. Usually, though not necessarily, these quantities take the form of electrical or magnetic signals capable of being stored, transferred, combined, compared, and otherwise manipulated. Programs may use data structures for both inputting information and producing the desired result. Data structures impart a physical organization on the data stored in computer memory and greatly facilitate data management. Databases include data structures and data.

The actual physical implementation of a database on a general purpose computer may take several forms, from complete individual records storing the substantive information with several key indexes for locating a particular record, to a plurality of tables interrelated by relational operations, to a matrix of cross-linked data records, to various combinations and hybrids of these general types. In particular physical devices, a database may be structured and arranged to accommodate the restrictions of the physical device but, when transferred to a general purpose computer, be able to be stored in a variety of formats. Thus, while certain types of information may be described as being stored in a “database” from a conceptual standpoint, generally such information may be electronically stored in a variety of structures with a variety of encoding techniques.

Although the following description details operations in terms of a graphic user interface using display objects, the present invention may be practiced with text based interfaces, or even with voice or visually activated interfaces.

Before delving into the various embodiments of the system and method according to the invention, general healthcare data management system concepts will be described. A healthcare data management system receives medical data from a plurality of sources and displays the data to facilitate diagnosis and treatment of patients. Medical data is stored in records in a database. Data has varying degrees of reliability depending on the source of the data. Data originating in devices external to the system, whether originated in a laboratory, a medical device, or generated manually in a computing device, must be transferred into the system before it may be analyzed and displayed by the system.

Data transfer mechanisms include downloading and merging. Downloading occurs when a device transmits a data file, or portions of a data file, to the system. Specifically, downloading occurs when a medical device is accessible to the system and transfers data directly to the system. Downloading also occurs when the data is first transferred to a computer storage media device before it is transferred from the computer storage media device to the system. Merging, on the other hand, occurs when a computing device selectively transfers data from an origin database, whether resident on the device or remote from it, to the system, or destination, database. Methods for downloading and merging are disclosed in the above-identified co-filed patent applications. The reliability of merged data, which might have been subject to modification in the origin database, might not be ascertainable unless the source of the data in the origin database is tracked.

The reliability of data depends on its source and on the circumstances under which it was obtained. As used herein, “source” refers to the origin of data. A data record may have multiple sources to represent the creation of the record and subsequent modifications of data in the record. The original source of the record may be a medical device while the source of a value in the record might be a manual modification.

Measurement data is unreliable when the test sample is not prepared or tested properly, or when the test results are changed before the results become part of the database. A test sample is not tested properly if the test protocol not followed or if the test instrument is un-calibrated or malfunctioning. Measurement data may also be unreliable if the test is subject to the influence of ambient conditions. Measurement data may also be subject to modifications, intentional or inadvertent, which undermine their reliability. Data entry error is one source of unreliability. Transcription and transmission errors are another source of unreliability.

One of the most reliable sources of data are analytical laboratories having sophisticated analytical equipment capable of transmitting the results of analysis directly into the system. Data may be transferred by means of the internet, direct logical communication to the system, or by means of data transfer devices including without limitation USB thumb-drives, DVDs, and CDs. Security encryption may be used to prohibit modification of the data prior to reception of the data by the system. High reliability results from procedures typically undertaken at analytical laboratories to calibrate instruments and maintain ambient conditions to provide stable testing environments.

Medical device data is also very reliable. A medical device performs tests and records test results automatically, and automation increases reliability. Although a device does not generally operate in a controlled environment, and might not be subject to rigorous calibration procedures, the device may be capable of some forms of self-calibration. Also, a medical device may record vast amounts of data, and the data may be analyzed to detect trends indicative of device de-calibration or other factors. Thus, medical device data is reliable.

Another type of data is manual data. Manual data may be provided by a health care professional (HCP) or a non-professional. A HCP facility is staffed by professionals trained in the collection and analysis of data. But, HCP generated data is still subject to data entry errors. On the other hand, manual data provided by a user who is not a professional might be less reliable due to, perhaps, a lower degree of training or proficiency in data collection and data entry.

It may be difficult to ascertain the origin of manual data. Manual data may originate in any device having a user input device. Manual data may also be included in merged data. Unless the source of the data is tracked, it may be difficult to trust it to the same degree as if it were automatically generated data.

In accordance with an aspect of the present invention, a system for displaying information in a screen display is provided. The system comprises a computer device and software applications. The system is configured to receive data from a medical device. In one embodiment, the computing device is integrated with the medical device. By integrated it is meant that the medical device has memory, a processor, a display device, and an user input device. In a further embodiment, the computing device is coupled with the medical device. By coupled it is meant that the medical device and the computing device may be attached so as to resemble an integrated device, and they may also be detached. While detached, the medical device may continue record medical data.

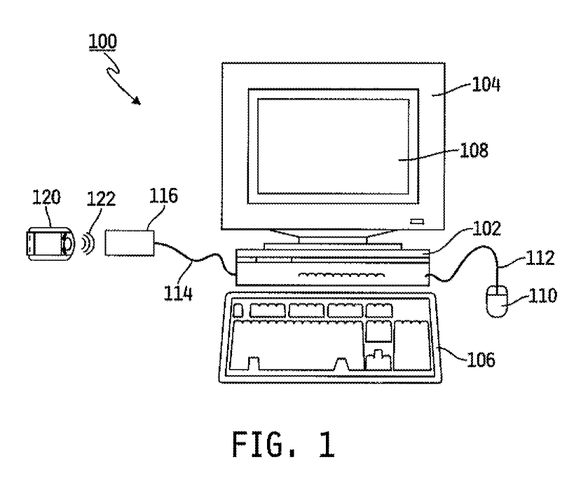

Turning now to the figures, FIG. 1 depicts an exemplary embodiment of a system 100 according to the invention for managing data. While the invention is applicable to any system capable of managing data and downloading data from a portable device, the invention is described herein with reference to healthcare data management software, and more particularly, with reference to diabetes management software. The invention may also be applied in fields unrelated to healthcare management. A particular embodiment of system 100 is the ACCU-CHEK® 360° diabetes management system distributed by Roche Diagnostics Corporation. The ACCU-CHEK®360° receives diabetes related data from a plurality of sources, allows users to modify data, and displays data in a plurality of formats and devices. To improve communication and understanding, the ACCU-CHEK® 360° allows users to choose when and how to display information. Users can choose from a plurality of graph formats, and can also choose how to graph data. Users can combine graphs, tables, and comments on the same screen display and can view the screen display on a computer screen or can print it. A method for customizing the presentation of data on an output device is disclosed in the above-identified co-filed patent applications.

The ACCU-CHEK® 360° software may be installed in a variety of configurations, e.g., personal and professional. The configurations determine whether some options are available to users. The ACCU-CHEK® 360° databases and software programs may be installed in a computing device comprising a personal computer or may be installed on a server. The system may download data from medical devices and may merge data from other databases. For example, a user who had been using another system may choose to upgrade to an ACCU-CHEK® 360° system. The ability to merge data allows the user to use the old data. The ACCU-CHEK® 360° system may also receive medical data from multiple patients. The ACCU-CHEK® 360° software may be installed to operate in one of many languages. In the professional installation, access to a plurality of patient result databases allows the ACCU-CHEK® 360° to display information comparing a particular patient's data to statistical data corresponding groups of patients.

The system 100 comprises a computing device 102, shown here in the form of a computer having a display device 104, in this case a computer video screen or monitor having a screen 108, and a keyboard 106. The computing device 102 has a mouse 110 connected to it by a cable 112. While a mouse 110 and a keyboard 106 are shown, the system 100 may comprise any user input device. The system 100 includes software applications (not shown) configured to receive data from user input devices. Components of a computing device 102 also include, but are not limited to, a processing unit and system memory.

A screen display refers to pixel data used to present an image on an output device. Generally, an application writes images in the form of pixel data to a memory array or frame buffer and provides the frame buffer data to the output device for presentation. Raster scanning is the most common method of image transmission to an output device such as a screen 108. The screen display may comprise display objects having images representing the shape, color, style, and other characteristics of the object.

The computing device 102 may include a variety of computer-readable media. Computer-readable media can be any available media that can be accessed by the computing device 102 and includes both volatile and non-volatile media, and removable and non-removable media. By way of example, and not limitation, computer-readable media may comprise computer storage media and communication media. The computer storage media provide storage of computer-readable instructions, software applications, data structures, program modules and other data for the computing device 102. A user may enter commands and data into the computing device 102 through a user input device such as a keyboard 106 and/or a mouse 110 or any other user input device. Other user input devices (not shown) may include a microphone, a joystick, a game pad, a satellite dish, a scanner, or the like. These and other input devices are often connected to the processing unit through a user input interface and may be connected by other interface and bus structures, such as a parallel port, game port or a universal serial bus (USB).

The computing device 102 may operate in a network environment using logical connections to one or more remote computers. The remote computer may be a personal computer, a server, a network PC, and typically includes many or all of the elements described above relative to computing device 102. The logical connections include a local area network (LAN) and a wide area network (WAN), but also include other networks. The terms “network,” “local area network,” “LAN,” “wide area network,” or “WAN” mean two or more computers which are connected in such a manner that messages may be transmitted between them. Such network environments are commonplace in office, enterprise-wide computer networks, Intranets, and the Internet. In such computer networks, typically one or more computers operate as a “server,” a computer with large storage media such as hard disk drives and communication hardware to operate peripheral devices such as printers or modems. Other computers, termed “clients” or “workstations,” provide a user interface so that users of computer networks can access the network resources, such as shared data files, common peripheral devices, and inter-workstation communication. The computers have at least one processor for executing machine instructions, and memory for storing instructions and other information. Many combinations of processing circuitry and information storing equipment are possible.

The system 100 comprises one or more software programs. The system 100 may comprise software configured to download data, to merge data from other origin databases, and to enable users to manually add and modify data. The system 100 may also comprise one or more databases for storing, retrieving, organizing, and, generally, for managing data. Data may include general data and patient data. In healthcare data management, the term “patient” refers to a person whose medical information is stored in the system 100. As used herein, patient data refers to data that can identify a patient including administrative data such as name, address, phone number, and medical data such as physiological parameter values including without limitation blood glucose values, A1c values, Albumin values, Albumin excretion values, body mass index values, blood pressure values, carbohydrate values, cholesterol values (total, HDL, LDL, ratio) creatinine values, fructosamine values, HbA1values, height values, insulin dose values, insulin rate values, total daily insulin values, ketone values, microalbumin values, proteinuria values, heart rate values, temperature values, triglyceride values, and weight values. Patient data may be provided by the patient, a healthcare professional, a medical device, a caregiver, or anyone having relevant data pertaining to a patient. In one embodiment, the databases are relational databases and the database server is the MICROSOFT SQL Server Express 2005. Computer 100 may include other applications required for operation of the SQL Server.

The system 100 is configured to provide medical data to, and receive data from, the medical device 120. In FIG. 1, the computing device 102 includes communication media 116, in this case a modulated signal transceiver, in logical communication with the processor and software applications by means of a cable 114, and configured to transmit and receive a modulated signal 122 to establish logical communication with the medical device 120. The communication media is typically embodied by computer-readable instructions, data structures, program modules or other data in a modulated data signal such as a carrier wave or other transport mechanism and includes any information delivery media. The term “modulated data signal” means a signal that has one or more of its characteristics set or changed in such a manner to encode information in the signal. By way of example, and not limitation, communication media includes wired media such as a wired network or direct wired connection, and wireless media such as acoustic, RF, infrared and other wireless media. Combinations of any of the above are included within the scope of computer-readable media.

Medical devices are devices capable of recording patient data and transferring data to software applications. They may include monitors which record values of measurements relating to a patient's physiological condition and information such as the time and date when the measurement was recorded. Medical devices may also be devices configured to provide medications to patients such as, for example, insulin pumps. These devices, generally, record dosage amounts as well as the time and date when the medication was provided. Optionally, medical devices may have their own user input devices and display devices. A medical device may also comprise a computing device integrated or coupled with a device for recording medical data including without limitation a computer, a personal digital assistant (PDA), a phone, a BLACKBERRY. Furthermore, the system 100 may be integrated with the medical device 120 thereby eliminating the necessity of generating and transmitting a modulated signal.

A medical device is, generally, assigned to a patient and associated with that patient in the system 100. Thus, when medical data from the medical device is transferred to the system 100, the medical data from the medical device automatically populates database records relating to that patient.

The system 100 is configured to display information in a plurality of forms and formats. While the screen display has been explained in detail with reference to a display device comprising a video screen for convenience, the term screen display is not intended to be so limiting. The screen display may be displayed in any output device capable of displaying mapped images of any kind. Thus, information may be shown by outputting a screen display onto, for example, a video screen, projecting it from a video projector, and by printing the screen display on a printer. The screen display may also be communicated via e-mail or fax.

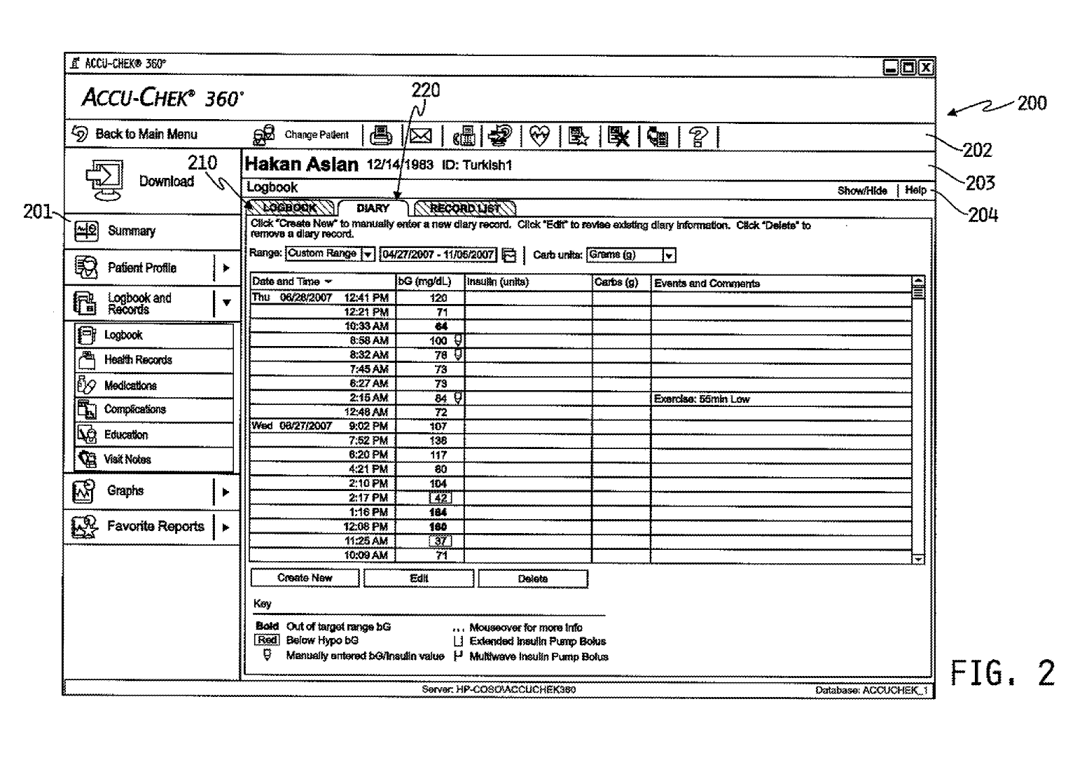

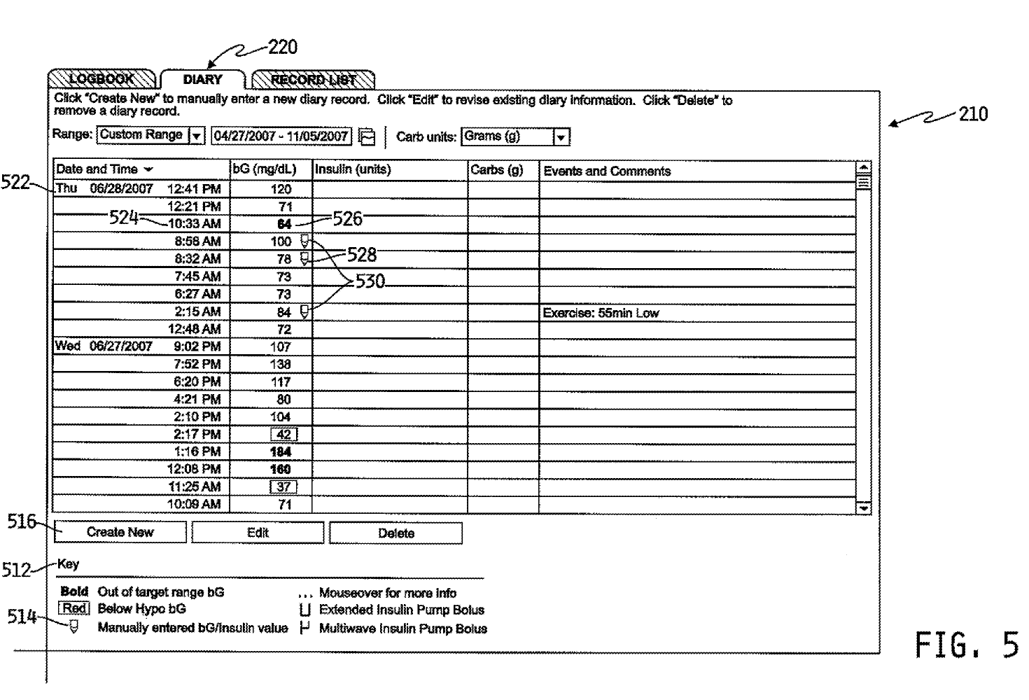

FIG. 2 depicts an exemplary embodiment of a method for displaying information generated in system 100 according to the invention. A screen display 200, generated by the ACCU-CHEK® 360° system, exhibits the first aspect of the method according to the invention. The screen display 200 shows a summary view of a patient's data comprising a primary menu 201 having display objects representing menu items titled summary, patient profile, logbooks and records, graphs, and favorite reports; a secondary menu 202 having display objects representing a plurality of functions such as change patient, print (icon depicting a printer), e-mail (icon depicting an envelope), etc.; a patient identification area 203 for displaying patient identification data; an options bar 204 for changing display options; and a logbook tabs portion 210 having tabs labeled Logbook, Diary, and Record List. The diary tab 220 is shown. Its contents are explained later with reference to FIG. 5 which is a larger view of the diary tab.

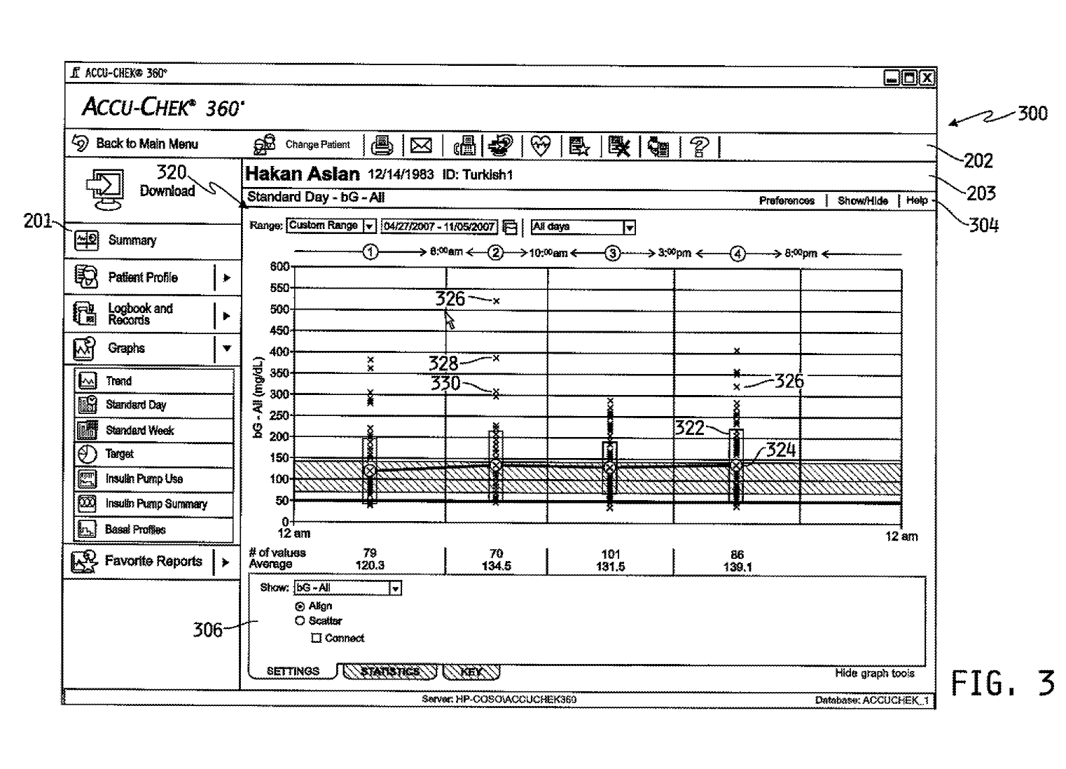

FIG. 3 depicts a screen display 300 of an ACCU-CHEK® 360° system displaying statistics relating to blood glucouse levels. The screen display 300 shows a primary menu 201 having display objects representing menu items titled summary, patient profile, logbooks and records, graphs, and favorite reports; a secondary menu 202 having display objects representing a plurality of functions such as change patient, print (icon depicting a printer), e-mail (icon depicting an envelope), etc.; a patient identification area 203 for displaying patient identification data; an options bar 304 for changing display options; a settings tab 306 at the bottom of the screen display for adapting the display of medical data; and a graph 320 labeled “Standard Day-bG-All” displaying a patient's medical data

Blood glucose, abbreviated bG, is an important physiological parameter for diabetic patients. It is a measurement of glucose or sugar levels in the patient's blood. Blood glucose levels are measured regularly and frequently using a type of medical device such as a glucose meter. Patients control blood sugar levels through medication, diet, physical activity, and other behaviors. The system 100 receives medical data, including bG data, pertaining to these parameters and may display the data in statistical, tabular, or other forms to ease interpretation. Similarly, the software may receive medical data pertaining to any of a plurality of physiological conditions of the patients and related medical devices.

The graph 320 shows a statistical representation of glucose levels for time periods corresponding to hours of the day. For each time period, the graph 320 shows bars 322 representing variation in blood glucose levels, mean markers 324, each depicted as an X inside a circle, and point markers 326, 328, 330. The graph 320 provides the user an overview of the patient's glucose levels during various timeframes.

In accordance with an aspect of the present invention, a method for displaying information in a screen display presented on the display device is provided. The method may be implemented in the computing device 100. In the first step of the method, a database tracks the source of medical data in the system 100. The database may track few or many modifications. The database may retain the original source and also subsequent sources of data. The database may also retain the original source and the source of the last modification of a value.

Source tracking may be accomplished by writing to the database the source of data or an indicator representing the source or type of data. In one embodiment, source tracking is accomplished by writing to the database text descriptive of the source of data including without limitation meter, pump, merged, and manual. Further, the descriptive text may contain a prefix to denote merged data, e.g., m-meter, m-pump, and m-manual. In another embodiment, source tracking is accomplished by writing to the database a code representing the source of data. The code may be a number, e.g., 1 to represent meters, 2 to represent pumps, 3 to represent merged data, 4 to represent annotations, 5 to represent manually added data, and 6 to represent modified data.

Further, the code may be indicative of the trust level associated with the data. Trust level may correspond to the source of the data, or may correspond to a predetermined level of reliability associated with the data which may, in part, be determined by the source of the data. In one embodiment, different codes are used to distinguish modifications to measurements from modifications to other data, such as the time or date of measurement, to reflect different levels of reliability or trust.

In another embodiment, the specific source of data may be tracked. Sources may be specific or general. A general source is a type of source, e.g., meter, manual, analytical device, medical device, and so on. A specific source may be a description or indication of a specific model or type of general source, e.g., serial number of a device, name of origin database for merged data, device model, and so on. In the case of manual data, the source may correspond to the specific user who modified the data.

Manual data is analogous to the terms “modify,” “modified,” and modifying” which refer herein to the act of altering data values. The terms are used to denote that manual data might not be as trustworthy as automatically collected data, e.g., from a meter or laboratory instrument. In other words, “manual data” is analogous with “modified” data in the sense that manual data is not provided automatically. The content of manual data might be generated automatically, but the additional step of entering data manually into a device affects its reliability.

There may be several types of modified data. Data may be modified by adding values. Addition may occur in a software application prior to downloading or merging into the system 100, or it may occur in the system 100. Another type of modification might be editing which refers to the altering of data values. As with addition, data may be edited in a medical device or in a computing device. Edition may occur in a software application prior to downloading or merging into the system 100, or it may occur in the system 100. A third type of modification might the deletion of data.

Another type of modification is annotation. Annotation means to add or modify text without changing data values. Databases may have fields in records for storing values and annotations on the same record. Alternatively, databases may have separate annotation tables for storing annotations. Annotations in annotation tables may be relationally related to the database containing data values such that a record containing values may be related to a plurality of annotations. Because annotations do not modify values, annotations may be considered more trustworthy than modified values.

Other types of modifications may be defined to track data sources. In the case of database merging, it may be desirable to track and distinguish merged data from unmerged data. Merged data could also be tracked depending on whether merging added or modified records. In one embodiment, new data is provided to the database and the original data values are retained.

A software application may associate the source of data with a display object. Alternatively, the software application may associate the source of data with a display object characteristic. The system may be designed to not associate display objects with a particular source of data while associating display objects with other sources of data. The absence of a distinguishing display object may distinguish and may be indicative of a particular trust level. The association may be static or interactive. Static association refers to an association that is fixed when the system 100 is designed. Static association may occur concurrently with source tracking. Interactive association refers to the ability of the system 100 to adapt and change display objects or display object characteristics relating to data sources according to user preferences.

In one embodiment, the display object associated with the source of data is a trust icon. In a more particular embodiment, a trust icon in the shape of a pencil is associated with manually modified data. The pencil icon may be associated with a modified record regardless of the type of modification. Alternatively, the pencil icon may only be associated with a modified record if a measurement value is modified.

In another particular embodiment, the database has an original source tracking field and second source tracking field. The original source tracking field may contain data corresponding to the original source of data including without limitation meter, pump, and manual, and a second field to denote that the data was modified. The second source tracking field may also indicate the type of manual modification, e.g., addition, annotation, edition and deletion.

The display objects may be created by combining images. Images may be combined into single display objects or may be presented as independent display objects to the screen display. In this context, a trust icon refers to the image of an icon whether the icon is combined with another image to create a display object, or is displayed as a display object by itself. A trust icon shaped as a pencil may be used to distinguish a specific data point. The trust icon may be placed next to the point marker or it may be provided to the screen display instead of the point marker. The icon may be provided to the screen display as an independent display object or it may be combined with the image of the point marker into a single display object. Any of the methods described provide a distinguishing display object to the screen display regardless of how the distinguishing characteristics are implemented.

In the second step, a software application generates a screen display including display objects which distinguish data based on the source of the data. The display objects may include without limitation trust icons and other display objects distinguishable based on their characteristics.

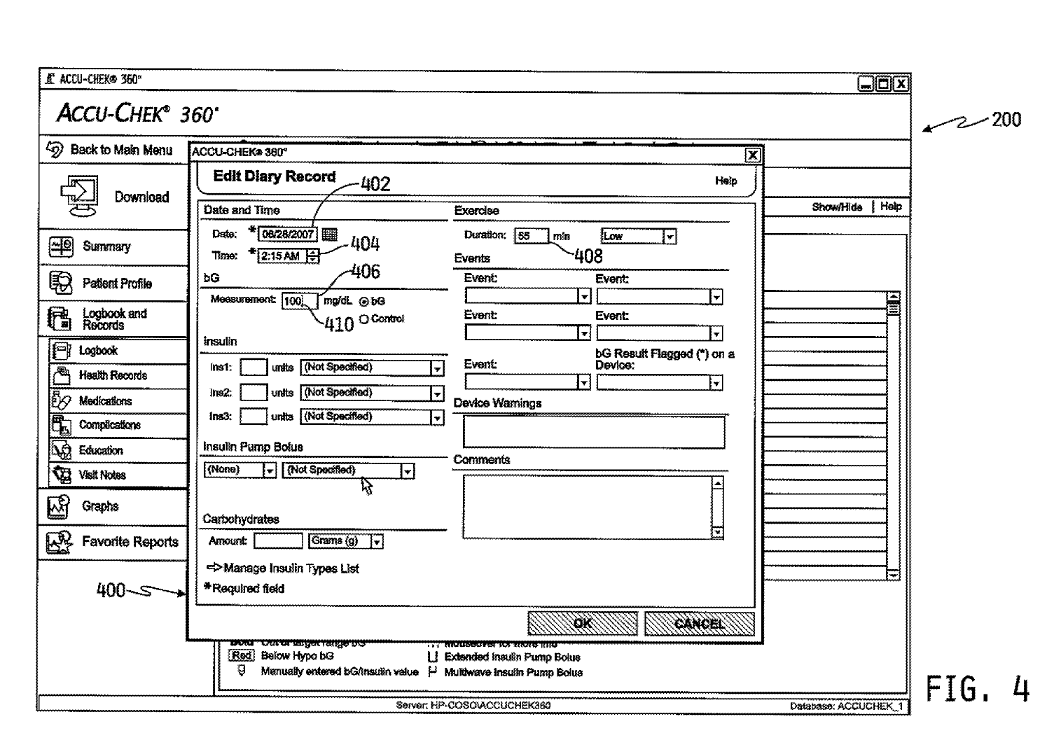

FIG. 4 depicts a screen display of an exemplary embodiment of the system 100 for modifying data in the database. The screen display comprises a record editing window 400 overlaying the previously described screen display 200. The record editing window 400 has display objects including a date object 402, a time object 404, a bG measurement object 406, and an exercise duration object 408 among others. The bG measurement object 406 shows a vertical bar 410 indicating the location of the cursor. A user may modify the value of the bG measurement by changing the content of the bG measurement object 406.

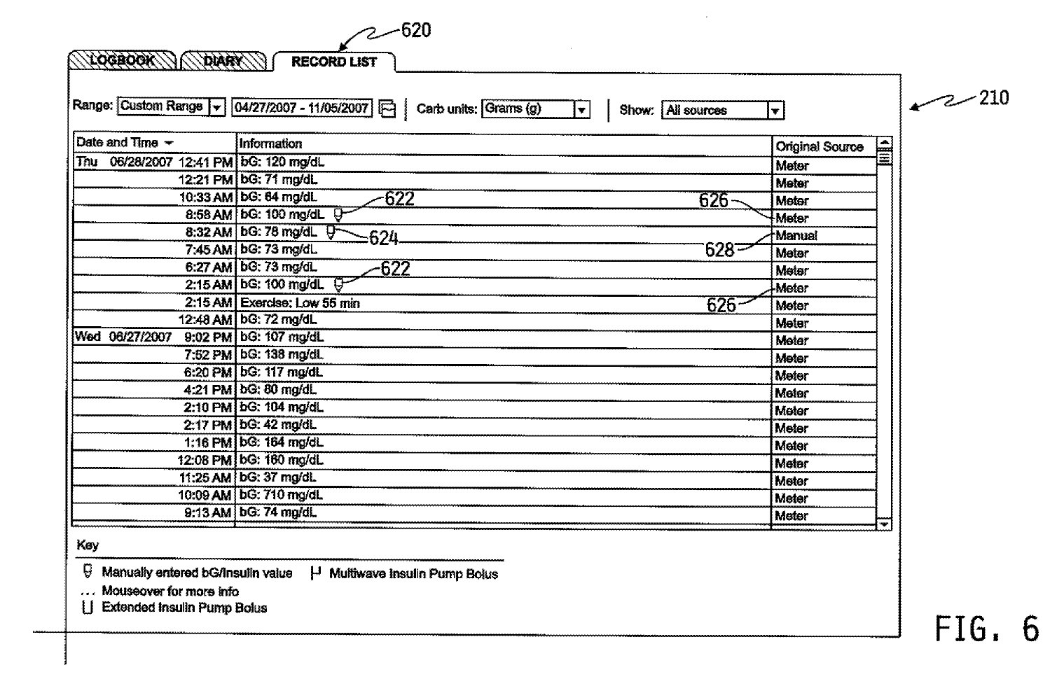

FIG. 5 depicts an exemplary embodiment of a portion of screen display 200 created with a system 100 according to the invention. The diary tab 220 of the logbook tabs portion 210 is shown. The diary tab 220 shows medical data in tabular form comprising the date and time of measurements, bG values, insulin values, carbs values, and events and comments descriptions. The date display object 522 shows that a number of measurements were taken on Thursday, Jun. 28, 2007. The time display object 524 shows that a bG value was measured on Thursday at 10:33 am. The bG display object 526 shows the value was 64 mg/dL. Exemplary display objects 528, 530 show trust icons each in the shape of a pencil denoting that the values were modified. An element 514 of the key 512 indicates that the pencil icon signifies a manually entered bG/Insulin value. A manual entry can be a value addition or a value change. The display object 516 may be activated to create a new record and, thus, to add data to the database. In this screen display, it is not possible to determine whether the values corresponding to display objects 528, 530 were added or edited, or whether the values are unchanged but the date or time of measurements were modified. As is shown with reference to FIG. 6, which reflects the same data that underlies the screen display in FIG. 5, the values associated with the display objects 530 were manually added. The original values associated with the display object 528 were obtained from a meter and subsequently edited.

FIG. 6 depicts another exemplary embodiment of a portion of the screen display 200 according to the invention created with a system 100. The record list tab 620 of the logbook tabs portion 210 is shown. The tab 620 shows in tabular form the date and time of measurements, medical data called “information” in the screen display, and the original source of the data. The exemplary display objects 622, 624 show trust icons each in the shape of a pencil denoting that the values associated with the icon were modified. The exemplary display objects 626, 628 show that the original values associated with the display objects 622 were obtained from a meter and subsequently edited, but that the value associated with the display object 624 was manually added.

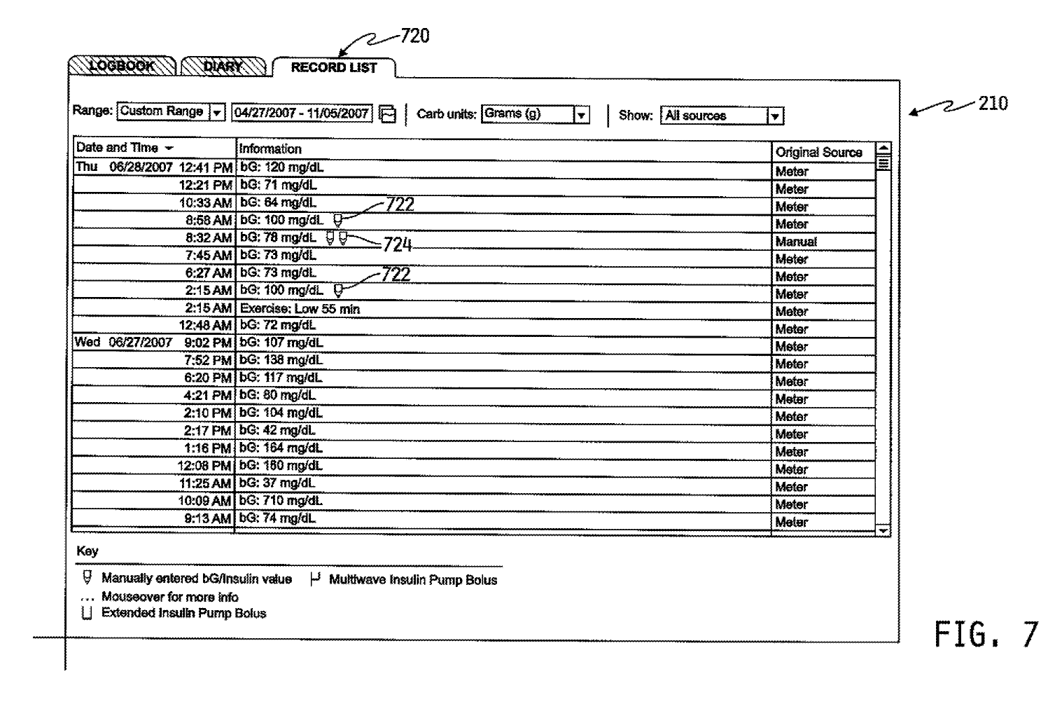

FIG. 7 depicts another exemplary embodiment of a portion of screen display 200 according to the invention created with a system 100. The record list tab 720 of the logbook tabs portion 210 is shown. The tab 720 shows in tabular form the date and time of measurements, medical data called information in the screen display, and the original source of the data. The exemplary display objects 722, 724 show trust icons. Unlike the trust icons of FIG. 6, the trust icons associated with the display objects 722 each have the shape of a pencil, in this case denoting that the original data source was a meter and that the values were edited. The trust icon associated with the display object 724, on the other hand, has the shape of two pencils denoting that the original data source was a manual entry. In this embodiment, the user can visually distinguish data sources by observing icons associated with different trust levels.

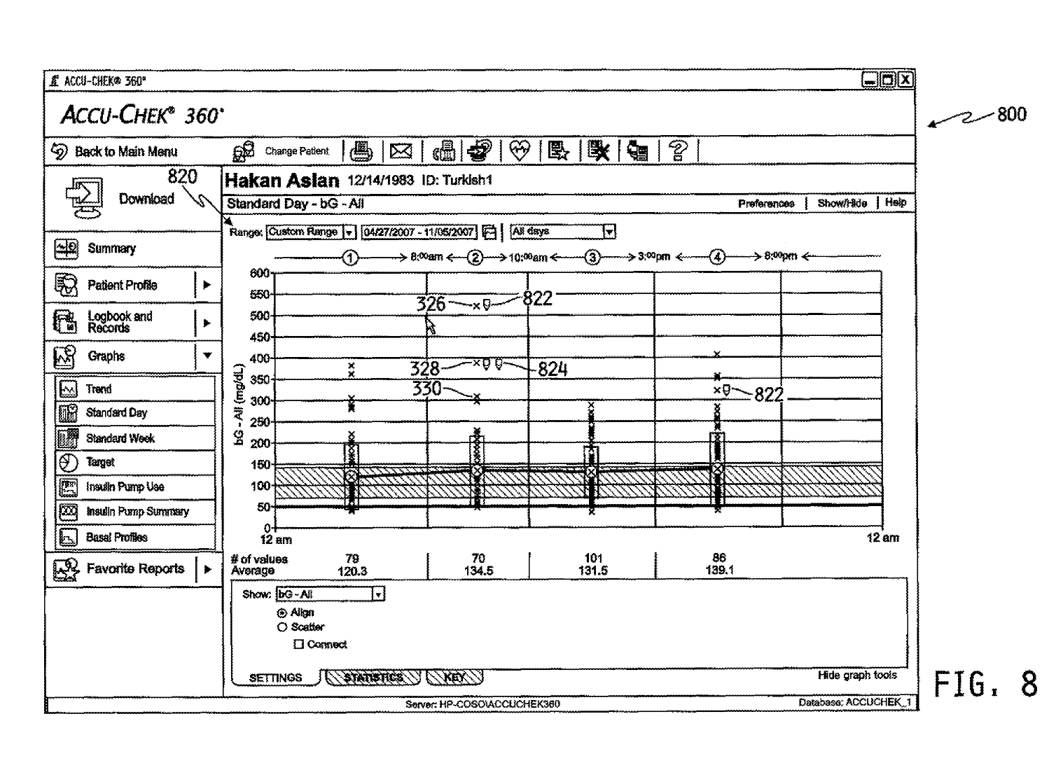

FIG. 8 depicts another exemplary embodiment of a screen display according to the invention. The screen display 800 has a graph 820 showing point markers 326, 328, 330 that is identical to the graph 320 except for the addition of the trust icons 822, 824. The trust icons 822 each have the shape of a pencil, in this case denoting that the original data source was a meter and that the values were edited. The trust icon 824 has the shape of two pencils denoting that the original data source was a manual entry. In this embodiment, the user can visually distinguish data sources in a graph by observing icons associated with different trust levels. While point markers and trust icons have been discussed as independent graphic images for convenience, multiple images associated with a data point may be combined and presented to the screen display as a single image. Thus, trust icon 822 and point marker 326 may be presented to the screen display as a single image. Likewise, trust icon 824 and point marker 328 may be presented as a single image.

In another embodiment, the software application may associate the source of data with a display object characteristic. Characteristics of display objects include without limitation color, shape, texture, emphasis, size, shade and style. A software application may, for example, change the shade of display objects according to the data sources associated with them. In one embodiment, point markers representing manually entered data may be of a color or shade distinguishable from the color and shade of point markers representing unmodified data uploaded from a meter or a pump. In another embodiment, point markers representing manually entered data may be of a shape distinguishable from the shape of point markers representing unmodified data uploaded from a meter or a pump.

In a further aspect of the method for displaying information according to the invention, the software application may distinguish data by providing to a screen display display objects representing a selection of the data. In one embodiment, data is selected according to a predefined selection criteria. The system 100 may be designed to numerically code the source of data. The code may be synonimous with a level of trust. For example, codes may range from level 1, indicating a low trust level, to level 10, the highest trust level. A software application may then apply the predefined selection criteria to select data and to only show display objects related to the selection. The software application may also be configured to show display objects related to data excluded from the selection.

In another embodiment, a user may interactivelly choose a selection criteria and whether to include or exclude display objects corresponding to the data from a screen display. For example, the system 100 may be designed to numerically code trust levels and to select data based on the selection of a code. The system 100 may be designed to numerically code the source of data. For example, codes may range from level 1, indicating a low trust level, to level 10, the highest trust level. A software application may then apply the chosen selection criteria to select data, either including or excluding matching data, and to show display objects related to the selection. Many variants of the coding method exemplified above are possible. Data may also be selected based on uncoded data such as the data's source. In one particular embodiment, selected data is distinguished by providing the screen display a display object describing the selection criteria or a description of the data subset displayed in the screen display.

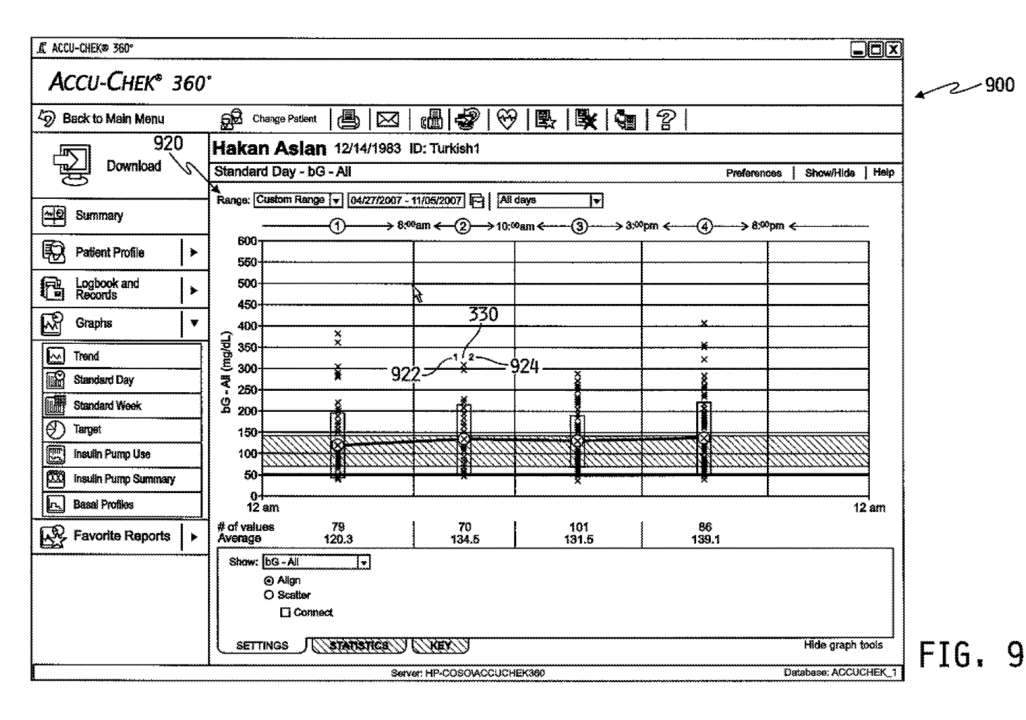

In a another aspect of the method for displaying information according to the invention, the application may distinguish data by providing to a screen display display objects representing deleted data. Deleted data may be represented by trust icons placed near data points originating earlier or later in time than the deleted data point. The location of the trust icon may indicate whether a data point was deleted prior or later in time. FIG. 9 depicts deleted data points. The screen display 900 has a graph 920 showing the point markers 330 that is identical to the graph 320 except for the addition of the trust icons 922, 924 and the deletion of the point markers 326, 328. The trust icon 922, in the shape of a “1,” denotes that a data point corresponding to a measurement taken earlier in time than the measurement corresponding to the point marker 330, was deleted. The trust icon 924, in the shape of a “2,” denotes that two data points corresponding to measurements taken later in time than the measurement corresponding to the point marker 330, were deleted. Illustrativelly, point markers 326, 328 are no longer shown.

Deleted data may be recognized in a number of ways. In one embodiment, a flag is written to a record preceeding or a record succeeding the record to be deleted to indicate the record's deletion. The flag may be used to locate a trust icon on a screen display. In another embodiment, a deletion flag is written to a record when a data value of the record is deleted. In yet another embodiment, the database assigns a record ID to each record added and deleted records are recognized by comparing IDs and detecting one or more skipped IDs.

In accordance with a further aspect of the present invention, a system for displaying information in a screen display is provided. The system comprises a computer device and computer programs. Further, the system also comprises a medical device configured to track the source of data. In one embodiment, the computing device is integrated with the medical device. In another embodiment, the computing device is coupled with the medical device.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method for indicating the source of data on a screen display, the method comprising the steps of:
tracking the source of data; and
providing a display object to a screen display corresponding to data, wherein the display object is configured to distinguish data according to the source of the data.

2. The method of claim 1 wherein tracking comprises the step of writing into a database the source of the data.

3. The method of claim 2 wherein the writing step is performed on a medical device.

4. The method of claim 2 wherein the writing step is performed on a computing device.

5. The method of claim 4 wherein the source is a medical device and the writing step is performed when a record is downloaded from the medical device to the computing device.

6. The method of claim 2, wherein the source of the data refers to the original source, further including the step of writing into the database an indicator of data modification.

7. The method of claim 2 wherein the source of the data is a modification.

8. The method of claim 7 wherein the indicator denotes a manual modification.

9. The method of claim 7 wherein the indicator is a type of data modification selected from the group consisting of adding, annotating, editing, deleting and merging.

10. The method of claim 1 wherein the tracking steps comprises the step of writing into a database an indicator corresponding to a trust level.

11. The method of claim 1 wherein tracking comprises the steps of writing into a database a new value and retaining the original value.

12. The method of claim 1 wherein the display object is configured to distinguish data based on one or more display objects characteristics.

13. The method of claim 12 wherein the display object characteristics consist of size, shape, color, shade, emphasis, texture and style.

14. The method of claim 12 wherein the display object comprises a trust icon.

15. The method of claim 1 further comprising the steps of:
providing selection criteria, wherein the selection criteria includes the source of data; and
selecting data according to the selection criteria, wherein the screen display is configured to distinguish data by displaying at least one display object corresponding to the selection.

16. The method of claim 15 wherein the data corresponding to the selection comprises data included in the selection.

17. The method of claim 15 wherein the data corresponding to the selection comprises data excluded from the selection.

18. The method of claim 15 wherein the selection criteria is provided interactively.

19. The method of claim 15 wherein the selection criteria is predefined.

20. The method of claim 15 wherein the at least one display object corresponding to the selection distinguishes data based on characteristics selected from the group consisting of size, shape, color, shade, emphasis, texture and style.

21. The method of claim 15 wherein the at least one display object corresponding to the selection distinguishes data by describing the selection criteria.

22. A system for indicating the source of data on a screen display comprising:
a computing device having an output device; and
computer programs; wherein the programs are configured to:
track the source of data; and
provide a display object to a screen display corresponding to data, wherein the display objects is configured to distinguish data according to the source of the data.

23. The system of claim 22 further including a medical device configured to track the source of data.

24. The system of claim 22 wherein the computing device is integrated with a medical device.

25. The system of claim 22 wherein the output device is a display device.
